(19) United States
(12) Patent Application Publication
(10) Pub. No.: US 2025/0231729 A1
(43) Pub. Date: Jul. 17, 2025

(54) ELECTRONIC DEVICE AND METHOD FOR CONTROLLING ELECTRONIC DEVICE

(71) Applicant: Samsung Electronics Co., Ltd., Suwon-si (KR)

(72) Inventors: Haeree NA, Suwon-si (KR); Jibum MOON, Suwon-si (KR); Eunjin LEE, Suwon-si (KR); Haein LEE, Suwon-si (KR)

(21) Appl. No.: 19/169,385

(22) Filed: Apr. 3, 2025

Related U.S. Application Data
(63) Continuation of application No. PCT/KR2023/018365, filed on Nov. 15, 2023.

(30) Foreign Application Priority Data
Nov. 18, 2022 (KR) 10-2022-0155757

(51) Int. Cl. G06F 3/14; G06F 3/0481; G06F 3/0488; G06F 3/16

(52) U.S. Cl. CPC G06F 3/1454; G06F 3/0481; G06F 3/0488; G06F 3/167

(57) ABSTRACT

Disclosed are an electronic device and a method for controlling the electronic device. The electronic device may comprise: a communication unit, a display, a memory, and a processor configured to control the communication unit such that: first content provided by a first external device is displayed in a first region of a first external display included in a first external device; while second content provided by a second external device connected to the first external device is being displayed in a second region of the first external display, information about the first content is received from a second external device connected to the electronic device through the communication unit; when a command for controlling an operation related to the first content is input, a control signal corresponding to the command is acquired; and a control signal and a request for transmitting the control signal to the first external device are transmitted to the second external device.

### CROSS-REFERENCE TO RELATED APPLICATIONS

This application is a continuation of International Application No. PCT/KR2023/018365 designating the United States, filed on Nov. 15, 2023, in the Korean Intellectual Property Receiving Office and claiming priority to Korean Patent Application No. 10-2022-0155757, filed on Nov. 18, 2022, in the Korean Intellectual Property Office, the disclosures of each of which are incorporated by reference herein in their entireties.

### BACKGROUND

### Field

The disclosure relates to an electronic device and a method for controlling the electronic device, and for example, to an electronic device that can control an operation related to a content being displayed on a display of an external device, and a method for controlling the electronic device.

### Description of Related Art

Recently, as technologies related to the Internet of Things (IoT) have developed, technologies for transmitting and receiving information on a content among a plurality of devices, and transmitting and receiving a control signal for controlling an operation related to the content also keep developing.

According to a conventional technology, in case a plurality of contents are displayed on an external device such as a TV, there may be a case wherein a user can control an operation related to a first content among the plurality of contents using a first device, but cannot control an operation related to a second content among the plurality of contents using the first device, or it is inconvenient to control the operation related to the second content using the first device.

For example, in the case of displaying a mirroring content corresponding to a screen that is being displayed on a smartphone on a TV together with a broadcasting content, a user may control the mirroring content using the smartphone. However, in this case, inconvenience may be caused in that the user should use a TV remote control or execute a separate application for controlling the TV on the smartphone to control the broadcasting content.

Compared to a case of using a TV remote control or a separate application on a smartphone, using another device in which the size of the display is big, or which has excellent portability or is appropriate for recognition of a user's gesture could be more appropriate for controlling a broadcasting content that is being displayed on a TV.

While there may be a device to which the same user as the user of the TV is registered among various devices of users, because of the characteristic of a TV that it could be used by a plurality of users, there may be a device to which the same user as the user of the TV is not registered among various devices of users.

Accordingly, there is a rising need for a technology for effectively controlling a content that is being displayed on an external device using characteristics of each of various devices of users, even in case the same user as the user of the external device such as a TV was not registered.

### SUMMARY

Embodiments of the disclosure address the limitation according to the conventional technology as described above, and provide an electronic device that can effectively control an operation related to a content that is being displayed on a display of an external device, and a method for controlling the electronic device.

According to an example embodiment of the disclosure, an electronic device includes: a communicator comprising communication circuitry, a display, memory, and at least one processor, comprising processing circuitry, individually and/or collectively, configured to: while a first content provided by a first external device is being displayed in a first area of a first external display included in the first external device and a second content provided by a second external device connected with the first external device is being displayed in a second area of the first external display, receive information on the first content from the second external device connected with the electronic device through the communicator, and based on an instruction for controlling an operation related to the first content being input, obtain a control signal corresponding to the instruction, and control the communicator to transmit the control signal and a request for transmitting the control signal to the first external device to the second external device.

The information on the first content may include image data corresponding to the first content, and at least one processor, individually and/or collectively, may, be configured to based on the image data, control the display to display the first content, and the instruction may be input based on a touch interaction for the area wherein the first content is displayed on the display.

The information on the first content may include information on a type of the first content, and at least one processor, individually and/or collectively, may be configured to control the display to display a user interface (UI) corresponding to the type of the first content, and the instruction may be input through the UI.

The electronic device may further include a sensor, and the instruction may be input based on the gesture detected through the sensor, and the instruction may correspond to one of a plurality of control instructions corresponding to the type of the first content.

The electronic device may further include a microphone, and the instruction may be input based on at least one of voices received through the microphone, and the instruction may correspond to one of a plurality of control instructions corresponding to the type of the first content.

The user may be registered to the electronic device may be the same as the user registered to the second external device, and may be a user not registered to the first external device.

The second content may be a content currently being displayed on a second external display included in the second external device.

The second content may be a content transmitted from a server to the first external device based on a user input that was input through the second external device.

At least one processor, individually and/or collectively, may be configured to, based on receiving the information on the first content from the second external device through the communicator, control the display to display a guide message indicating that the operation related to the first content can be controlled.

According to an example embodiment of the disclosure, a method for controlling an electronic device includes: while a first content provided by a first external device is being displayed in a first area of a first external display included in the first external device and a second content provided by a second external device connected with the first external device is being displayed in a second area of the first external display, receiving information on the first content from the second external device connected with the electronic device, and based on an instruction for controlling an operation related to the first content being input, obtaining a control signal corresponding to the instruction, and transmitting the control signal and a request for transmitting the control signal to the first external device to the second external device.

The information on the first content may include image data corresponding to the first content, and the controlling method for an electronic device may further include, based on the image data, displaying the first content, and the instruction may be input based on a touch interaction for the area wherein the first content is displayed on the display.

The information on the first content may include information on a type of the first content, and the controlling method for an electronic device may further include displaying a user interface (UI) corresponding to the type of the first content, and the instruction may be input through the UI.

The instruction may be input based on the gesture, and the instruction may correspond to one of a plurality of control instructions corresponding to the type of the first content.

The instruction may be input based on at least one of voices, and the instruction may correspond to one of a plurality of control instructions corresponding to the type of the first content.

The user registered to the electronic device may be the same as the user registered to the second external device, and may be a user not registered to the first external device.

The second content may be a content currently being displayed on a second external display included in the second external device.

The second content may be a content transmitted from a server to the first external device based on an input that was input through the second external device.

The controlling method for an electronic device may further include, based on receiving the information on the first content from the second external device, displaying a guide message indicating that the operation related to the first content can be controlled.

According to an example embodiment of the disclosure, in a non-transitory computer-readable recording medium including a program which, when executed by at least one processor, individually and/or collectively, of an electronic device, caused the electronic device, the to perform operations comprising: while a first content provided by a first external device is being displayed in a first area of a first external display included in the first external device and a second content provided by a second external device connected with the first external device is being displayed in a second area of the first external display, receiving information on the first content from the second external device connected with the electronic device, and based on an instruction for controlling an operation related to the first content being input, obtaining a control signal corresponding to the instruction, and transmitting the control signal and a request for transmitting the control signal to the first external device to the second external device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device, a first external device, and a second external device according to various embodiments;

FIG. 2 is a block diagram illustrating an example configuration of an electronic device according to various embodiments;

FIG. 3 is a diagram illustrating an example control process of an electronic device for controlling an operation related to a first content according to various embodiments;

FIG. 4 is a block diagram illustrating an example configuration of an electronic device according to various embodiments;

FIG. 5 is a diagram illustrating an example control process of an electronic device for controlling an operation related to a first content according to various embodiments; and

FIG. 6 is a flowchart illustrating an example method of controlling an electronic device according to various embodiments.

### DETAILED DESCRIPTION

Various modifications may be made to the various example embodiments of the disclosure, and there may be various example embodiments. Accordingly, various embodiments will be illustrated in drawings, and the various embodiments will be described in greater detail in the detailed description. However, it should be noted that the various embodiments are intended to limit\ the scope of the disclosure, but they should be interpreted to include various modifications, equivalents, and/or alternatives of the various embodiments of the disclosure. With respect to the drawings, similar components may be designated by similar reference numerals.

In describing the disclosure, in case it is determined that detailed explanation of related known functions or components may unnecessarily confuse the gist of the disclosure, the detailed explanation may be omitted.

The various embodiments described below may be modified in various different forms, and the scope of the technical idea of the disclosure is not limited to the various embodiments below. Rather, these example embodiments are provided to make the disclosure more sufficient and complete.

Terms used in the disclosure are used simply to explain specific embodiments, and are not intended to limit the scope of the disclosure. Singular expressions include plural expressions, unless clearly different in context.

In the disclosure, expressions such as “have,” “may have,” “include,” and “may include” denote the existence of such characteristics (e.g.: elements such as numbers, functions, operations, and components), and do not exclude the existence of additional characteristics.

In the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

The expressions “first,” “second,” and the like used in the disclosure may describe various elements regardless of any order and/or degree of importance. Such expressions are used simply to distinguish one element from another element, and are not intended to limit the elements.

The description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

The description that one element (e.g.: a first element) is “directly coupled” or “directly connected” to another element (e.g.: a second element) can be interpreted to refer, for example, to still another element (e.g.: a third element) not existing between the one element and the another element.

The expression “configured to” used in the disclosure may be interchangeably used with other expressions such as “suitable for,” “having the capacity to,” “designed to,” “adapted to,” “made to,” and “capable of,” depending on cases. The term “configured to” may not necessarily refer to a device being “specifically designed to” in terms of hardware.

Under some circumstances, the expression “a device configured to” may refer, for example, to the device being “capable of” performing an operation together with another device or component. For example, the phrase “a processor configured to perform A, B, and C” may refer to a dedicated processor (e.g.: an embedded processor) for performing the corresponding operations, or a generic-purpose processor (e.g.: a CPU or an application processor) that can perform the corresponding operations by executing one or more software programs stored in a memory device.

In various embodiments of the disclosure, ‘a module’ or ‘a unit’ may perform at least one function or operation, and may be implemented as hardware or software, or as a combination of hardware and software. A plurality of ‘modules’ or ‘units’ may be integrated into at least one module and implemented as at least one processor, excluding ‘a module’ or ‘a unit’ that needs to be implemented as specific hardware.

Various elements and areas in the drawings were illustrated schematically. Accordingly, the technical idea of the disclosure is not limited by the relative sizes or intervals illustrated in the accompanying drawings.

Various example embodiments according to the disclosure will be described in greater detail with reference to the accompanying drawings.

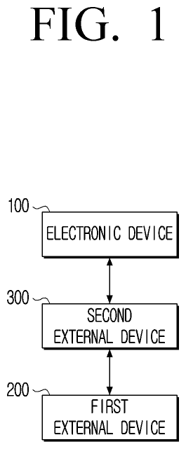

FIG. 1 is a block diagram illustrating an example configuration of an electronic device 100, a first external device 200, and a second external device 300 according to various embodiments.

The first external device 200 refers to a device that can display a content. For example, the first external device 200 may be implemented as a digital TV or a monitor, etc., but is not limited thereto.

For example, the first external device 200 may simultaneously display different contents in each of different areas of a first external display included in the first external device 200. For example, in a first area of the first external display included in the first external device 200, a first content may be displayed, and a second content may be displayed in a second area.

In the disclosure, the first content is used as a term for generally referring to contents provided by the first external device 200. For example, in case the first external device 200 is implemented as a digital TV, the first content may be a broadcasting content provided by the first external device 200 or a broadcasting reception device (e.g.: a set-top box) connected to the first external display 200, and may be various contents other than them.

The second external device 300 refers to a device that can provide the second content displayed in some areas of the first external display included in the first external device 200. For example, the second external device 300 may be implemented as a smartphone or a tablet PC, etc., but is not limited thereto.

For example, the second external device 300 may be connected with the first external device 200, and provide the second content to the first external device 200. Also, the second external device 300 may transmit a control signal for controlling an operation related to the second content to the first external device 200.

In the disclosure, the second content is used as a term for generally referring to contents provided to the first external device 200 by the second external device 300. For example, in case the second external device 300 is implemented as a smartphone, the second content may be a content that is currently being displayed on a second external display included in the second external device 300. The second content may be a content that is transmitted from a server to the first external device 200 based on a user input that was input through the second external device 300. That is, the second external device 300 may make the second content displayed on the first external display of the first external display 200 by mirroring or casting.

The electronic device 100 refers to a device that can control a content displayed on the first external display 200. For example, the electronic device 100 may be implemented as a smartphone, a tablet PC, a smart watch, a digital pen, and wireless earphones, etc., but is not limited thereto.

For example, the electronic device 100 may be connected with the second external device 300, and receive information on a content displayed on the first external display included in the first external device 200 through the second external device 300, and transmit a control signal to the first external device 200 through the second external device 300.

For example, the user registered to the electronic device 100 may be the same as the user registered to the second external device 300, and may be a user not registered to the first external device 200. In other words, even in case the user registered to the electronic device 100 does not coincide with the user registered to the second external device 300, the electronic device 100 may implement various embodiments according to the disclosure through communicative connection with the first external device 200 wherein the registered user coincides.

There is no special limitation on a commutative connection method between the electronic device 100 and the second external device 300, and a commutative connection method between the second external device 300 and the first external device 200.

In the explanation regarding the disclosure, explanation will be described mainly based on the premise of a case wherein the electronic device 100 is connected with the second external device 300, and is not connected with the first external device 200, but depending on embodiments, the electronic device 100 and the first external device 200 can clearly be connected directly, and perform communication between each other.

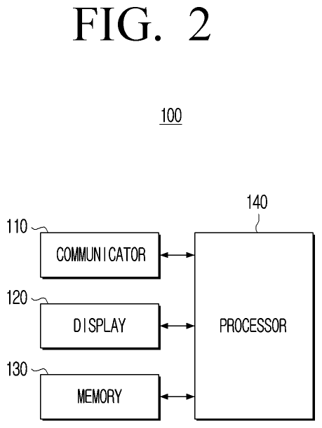

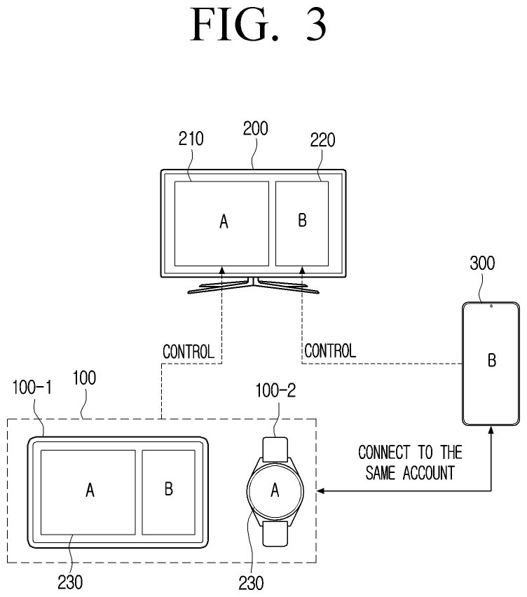

FIG. 2 is a block diagram illustrating an example configuration of the electronic device 100 according to various embodiments, and FIG. 3 is a diagram illustrating an example control process of the electronic device 100 for controlling an operation related to a first content according to various embodiments. Hereinafter, various embodiments of the disclosure will be explained with reference to FIG. 2 and FIG. 3 together.

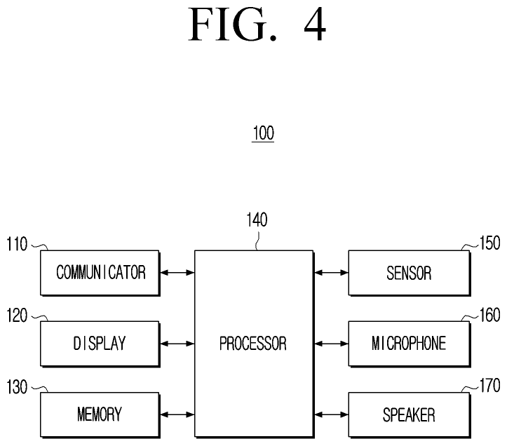

As illustrated in FIG. 2, the electronic device 100 according to an embodiment of the disclosure may include a communicator (e.g., including communication circuitry) 110, a display 120, memory 130, and a processor (e.g., including processing circuitry) 140. As illustrated in FIG. 4, the electronic device 100 may further include a sensor 150, a microphone 160, and a speaker 170.

The communicator 110 includes circuitry, and may perform communication with an external device. Specifically, the processor 140 may receive various types of data or information from an external device connected through the communicator 110, and transmit various types of data or information to the external device.

The communicator 110 may include at least one of a Wi-Fi module, a Bluetooth module, a wireless communication module, an NFC module, or an ultra wide band (UWB) module. Specifically, a Wi-Fi module and a Bluetooth module may perform communication by a Wi-Fi method and a Bluetooth method, respectively. In the case of using a Wi-Fi module or a Bluetooth module, various types of connection information such as an SSID, etc. is transmitted and received first, and connection of communication is performed using the information, and various types of information can be transmitted and received thereafter.

A wireless communication module may perform communication according to various communication standards such as IEEE, Zigbee, 3rd Generation (3G), 3rd Generation Partnership Project (3GPP), Long Term Evolution (LTE), 5th Generation (5G), etc. In addition, an NFC module may perform communication by a near field communication (NFC) method using a 13.56 MHz band among various RF-ID frequency bands such as 135 kHz, 13.56 MHz, 433 MHz, 860-960 MHz, 2.45 GHz, etc. Further, a UWB module can correctly measure a Time of Arrival (ToA) which is the time that a pulse reaches a target, and an Angle of Arrival (AoA) which is a pulse arrival angle in a transmission device through communication between UWB antennas, and accordingly, the UWB module can perform precise distance and location recognition in an error range of within scores of cm indoors.

For example, in various embodiments according to the disclosure, the processor 140 may receive information on a content displayed on the first external device 200 from at least one of the first external device 200 or the second external device 300 through the communicator 110. The processor 140 may control the communicator 110 to transmit a control signal for controlling an operation related to the content displayed on the first external device 200 to at least one of the first external device 200 or the second external device 300. Then, in the case of transmitting the control signal to the second external device 300, the processor 140 may control the communicator 110 to transmit a request for transmitting the control signal to the first external device 200 together with the control signal to the second external device 300.

The display 120 may output image data by control by the processor 140. For example, the display 120 may output an image stored in advance in the memory 130 under control of the processor 140. The display 120 may display a user interface (UI) stored in the memory 130.

The display 120 may be implemented, for example, and without limitation, as a liquid crystal display (LCD) panel, organic light emitting diodes (OLED), etc. The display 120 may be implemented as a flexible display, a transparent display, etc. depending on cases. However, the display 120 according to the disclosure is not limited to a specific type.

For example, in the various embodiments according to the disclosure, the processor 140 may control the display 120 to display the first content based on image data corresponding to the first content. The processor 140 may control the display 120 to display a UI corresponding to the type of the first content based on information on the type of the first content.

In the memory 130, at least one instruction regarding the electronic device 100 may be stored. Also, in the memory 130, an operating system (O/S) for operating the electronic device 100 may be stored. In addition, in the memory 130, various types of software programs or applications for making the electronic device 100 operate according to the various embodiments of the disclosure may be stored. Further, the memory 130 may include semiconductor memory such as flash memory or a magnetic storage medium such as a hard disk, etc.

For example, in the memory 130, various types of software modules for the electronic device 100 to operate according to the various embodiments of the disclosure may be stored, and the processor 140 may control the operations of the electronic device 100 by executing the various types of software modules stored in the memory 130. That is, the memory 130 may be accessed by the processor 140, and reading/recording/correction/deletion/update, etc. of data by the processor 140 may be performed.

In the disclosure, the term memory 130 may be used as a meaning including the memory 130, ROM (not shown) and RAM (not shown) inside the processor 140, or a memory card (not shown) (e.g., a micro SD card, a memory stick) installed on the electronic device 100.

For example, in various embodiments according to the disclosure, in the memory 130, various types of information such as information on a user's account, information on the first content, information on the second content, information on a user instruction, information on a control signal, and information on a UI, etc. may be stored. Other than the above, various types of information necessary within a range for achieving the purpose of the disclosure may be stored in the memory 130, and the information stored in the memory 130 may be updated as information is received from an external device or input by a user.

The processor 140 may include various processing circuitry and controls the overall operations of the electronic device 100. The processor 140 may be implemented as at least one processor 140. For example, the processor 140 may be connected with the components of the electronic device 100 including the communicator 110, the display 120, and the memory 130, and control the overall operations of the electronic device 100 by executing the at least one instruction stored in the memory 130 as described above.

The processor 140 may be implemented in various ways. For example, the processor 140 may be implemented as at least one of an application specific integrated circuit (ASIC), an embedded processor, a microprocessor, a hardware control logic, a hardware finite state machine (FSM), or a digital signal processor (DSP). In the disclosure, the term processor 140 may be used as a meaning including a central processing unit (CPU), a graphic processing unit (GPU), a main processing unit (MPU), etc. The processor 140 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, in the various embodiments according to the disclosure, the processor 140 may receive information on a content displayed on the first external display of the first external device 200, and make a control signal for controlling an operation related to the content transmitted to the first external device 200.

The first content provided by the first external device 200 may be displayed in the first area of the first external display included in the first external device 200, and the second content provided by the second external device 300 connected with the first external device 200 may be displayed in the second area of the first external display. In FIG. 3, it was indicated that the first content A is being displayed in the first area 210 of the first external display, and the second content B is being displayed in the second area 220.

For example, in the first area and the second area of the first external display, the first content and the second content may be displayed as a multi-view. Here, the first area and the second area may not only be divided areas on the first external display, but one area from among the first area and the second area may also be arranged on the other one area. For example, the first content and the second content may be provided on the first external display by a picture in picture (PIP) or a picture by picture (PBP) method.

While the first content and the second content are being displayed on the first external display, the first content may be controlled through an input part included in the first external device 200 or a remote control device for controlling the first external device 200, etc. as a content provided by the first external device 200. Also, the second content may be controlled by the second external device 300 as a content provided by the second external device 300, and for example, a content provided by mirroring or casting. According to the various embodiments of the disclosure, the electronic device 100 may control an operation related to the first content or an operation related to the second content. However, hereinafter, embodiments related to the electronic device 100 controlling an operation related to the first content will be mainly explained.

While the first content and the second content are being displayed on the first external display, the processor 140 may receive information on the first content from the second external device 300 connected with the electronic device 100 through the communicator 110. When the information on the first content is received from the second external device 300, the processor 140 may control the display 120 to display a guide message indicating that an operation related to the first content can be controlled. If a user instruction (or user command) for controlling the operation related to the first content is input, the processor 140 may obtain a control signal corresponding to the user instruction.

According to an embodiment, the information on the first content may include image data corresponding to the first content. In this case, the processor 140 may control the display 120 to display the first content based on the image data. Also, a user instruction may be input based on a user's touch interaction for the area wherein the first content is displayed on the display 120.

Referring to the example in FIG. 3, the electronic device 100 may be implemented as a tablet PC 100-1 as illustrated in FIG. 3. In case the electronic device 100 is implemented as the tablet PC 100-1, the processor 140 may receive image data corresponding to the first content from the second external device 300 through the communicator 110.

When the image data corresponding to the first content is received, the processor 140 may control the display 120 to display the first content. The processor 140 may receive image data corresponding to the second content together with the image data corresponding to the first content, and control the display 120 to display the second content together with the first content. The screens A and B of the first external device 200 and the screens A and B of the electronic device 100 in FIG. 3 indicate that the first content and the second content displayed on the first external display of the first external device 200 are being displayed in one area 230 of the display 120 of the tablet PC 100-1.

While the first content is being displayed on the display 120, the processor 140 may receive the user's touch interaction regarding the area wherein the first content is displayed, and obtain a control signal corresponding to the received touch interaction of the user. Here, the touch interaction may be one of various touch interactions such as tap, double tap, hold, flick, drag and drop, pinch in, and pinch out, etc.

Referring to the example in FIG. 3, the electronic device 100 may be implemented as a smart watch 100-2 as illustrated in FIG. 3. In case the electronic device 100 is implemented as the smart watch 100-2, the processor 140 may receive image data corresponding to the first content from the second external device 300 through the communicator 110.

When the image data corresponding to the first content is received, the processor 140 may control the display 120 to display the first content. The processor 140 may receive image data corresponding to the second content together with the image data corresponding to the first content, and control the display 120 to display the second content together with the first content. The screen A of the smart watch 100-2 in FIG. 3 indicates that the first content displayed on the first external display of the first external device 200 is being displayed on the display 120 of the smart watch 100-2.

In case the first content is displayed on the display 120 of the smart watch 100-2, the processor 140 may change the content displayed on the display 120 from the first content to the second content based on a user instruction (e.g.: a swipe gesture) for changing the content displayed on the display 120.

According to an embodiment, the information on the first content may include information on the type of the first content. In this case, the processor 140 may control the display 120 to display a user interface (UI) corresponding to the type of the first content. Also, a user instruction may be input through the UI displayed on the display 120.

In the information on the type of the first content, the first content may include various contents such as a broadcasting content, an over-the-top (OTT) content, and a game content, etc. Also, the UI corresponding to the type of the first content may include a plurality of UI items for controlling a related operation according to the type of the first content.

In case the first content is a broadcasting content or an OTT content, the processor 140 may display a UI including a plurality of UI items for controlling operations related to a broadcasting content, e.g., operations such as change of the channel, change of the volume, etc.

In case the first content is a game content, the processor 140 may display a UI including a plurality of UI items related to a game content, e.g., a plurality of UI items such as four-direction keys, a confirm key, a cancel key, a menu key, etc.

While a UI corresponding to the type of the first content is being displayed on the display 120, the processor 140 may receive a user instruction selecting one of the plurality of UI items included in the UI, and obtain a control signal corresponding to the received user instruction.

When the control signal corresponding to the user instruction is obtained, the processor 140 may control the communicator 110 to transmit a control signal and a request for transmitting the control signal to the first external device 200 to the second external device 300. That is, in case communicative connection was not performed between the electronic device 100 and the first external device 200, the processor 140 may make a control signal for controlling an operation related to the first content provided by the first external device 200 transmitted to the first external device 200 through the second external device 300.

According to the aforementioned embodiment, in case registration of the same user as the user of an external device was not performed, the electronic device 100 can effectively control a content that is being displayed on the first external device 200.

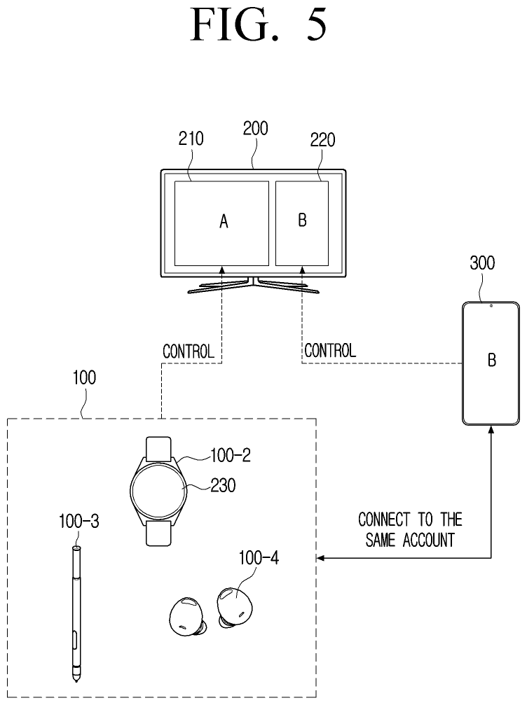

FIG. 4 is a block diagram illustrating an example configuration of the electronic device 100 according to various embodiments, and FIG. 5 is a diagram illustrating an example control process of the electronic device 100 for controlling an operation related to a first content. Hereinafter, various embodiments of the disclosure will be explained with reference to FIG. 4 and FIG. 5 together.

As illustrated in FIG. 4, the electronic device 100 according to an embodiment of the disclosure may include not only the communicator (e.g., including communication circuitry) 110, the display 120, the memory 130, and the processor (e.g., including processing circuitry) 140, but also further include a sensor 150, a microphone 160, and a speaker 170, etc. However, the components as illustrated in FIG. 2 and FIG. 4 are merely examples, and in carrying out the disclosure, new components can be added in addition to the components as illustrated in FIG. 2 and FIG. 4, or some components may be omitted.

For example, the electronic device 100 may include only some of the communicator 110, the display 120, the memory 130, the processor 140, the sensor 150, the microphone 160, and the speaker 170. As illustrated in FIG. 5, in case the electronic device 100 is implemented as the smart watch 100-2 wherein the size of the display 120 is not big, or implemented as a digital pen 100-3 or wireless earphones 100-4, etc. not including the display 120, it may be inappropriate to display the first content itself or display a UI corresponding to the type of the first content, or it may not be possible to display them, as in the various embodiments described above with reference to FIG. 2 and FIG. 3. In FIG. 5, it was indicated that the first content itself is not displayed in the area 230 of the display of the smart watch 100-2. In this case, the processor 140 may implement the various embodiments according to the disclosure using at least one of the sensor 150, the microphone 160, or the speaker 170.

The sensor 150 may detect various types of information inside and outside the electronic device 100. Specifically, the sensor 150 may include at least one of a global positioning system (GPS) sensor, a gyro sensor (a gyroscope), an acceleration sensor (an accelerometer), a LiDAR sensor, an inertial measurement unit (IMU), or a motion sensor. In addition, the sensor 150 may include various types of sensors such as a temperature sensor, a humidity sensor, an infrared sensor, a bio sensor, etc.

For example, in the various embodiments according to the disclosure, the sensor 150 may include at least one of a gyro sensor, an IMU, or a motion sensor that can detect movements of the electronic device 100. Also, a user instruction may be input based on the user's gesture detected through the sensor 150, and the user instruction may correspond to one of a plurality of control instructions corresponding to the type of the first content.

According to an embodiment, in case the electronic device 100 is implemented as the smart watch 100-2, the digital pen 100-3, the wireless earphones 100-4, etc. as illustrated in FIG. 4, the processor 140 may identify the user's gesture by detecting a movement of the electronic device 100 through the sensor 150, and identify a user instruction corresponding to the identified gesture among the plurality of control instructions corresponding to the type of the first content.

For example, if a movement that the smart watch 100-2 or the digital pen 100-3 which is the electronic device 100 moves at greater than or equal to threshold acceleration in a direction corresponding to the direction of gravity is detected through the sensor 150, the processor 140 may identify that the user instruction corresponds to an operation which is decrease of the volume of the first content.

As another example, if it is detected that the wireless earphones 100-4 which is the electronic device 100 was separated from the user's body through the sensor 150, the processor 140 may identify that the user instruction corresponds to an operation which is stopping of reproduction of the first content. Other than the above, user instructions according to various movements of the electronic device 100 may have been defined in advance, and information on mapping between movements of the electronic device 100 and user instructions may be stored in the memory 130.

The microphone 160 may obtain a signal regarding a sound or a voice that was generated outside the electronic device 100. For example, the microphone 160 may obtain vibration according to a sound or a voice that was generated outside the electronic device 100, and convert the obtained vibration into an electric signal.

For example, the microphone 160 according to the disclosure may obtain a voice signal for a user voice that was generated by the user's utterance. Then, the obtained signal may be converted into a signal in a digital form, and stored in the memory 130. The microphone 160 may include an analog to digital (A/D) converter, and may operate by being interlocked with an A/D converter located outside the microphone 160.

According to an embodiment, in case the electronic device 100 is implemented as the smart watch 100-2, the wireless earphones 100-4, etc. as illustrated in FIG. 4, the processor 140 may receive a user voice through the microphone 160, and identify a user instruction corresponding to the received user voice. For example, the processor 140 may input a user voice received through the microphone 160 into a trained neural network model (e.g.: an automatic speech recognition (ASR) model) and obtain text information corresponding to the received user voice, and identify a user instruction corresponding to the obtained text information among the plurality of control instructions corresponding to the type of the first content.

The speaker 170 may output audio data by control by the processor 140. In particular, in the various embodiments according to the disclosure, when the information on the first content is received from the second external device 300 through the communicator 110, the processor 140 may control the speaker 170 to output a voice indicating that an operation related to the first content can be controlled.

In the above, an embodiment wherein one electronic device 100 controls an operation regarding a content displayed on the first external display of the first external device 200 was described, but the disclosure is not limited thereto. That is, the various embodiments of the disclosure can be implemented through a plurality of electronic devices 100.

For example, as in an operation wherein the user adjusts the size of the first content displayed on the first external display of the first external device 200 by inputting a pinch out interaction using the tablet PC 100-1 among the plurality of electronic devices 100, and adjusts the volume of the first content using the wireless earphones 100-4 among the plurality of electronic devices 100, the plurality of electronic devices 100 may be used together in control of an operation regarding a content displayed on the first external display of the first external device 200.

When the information on the first content is received from the second external device 300, the plurality of electronic devices 100 may display a guide message indicating that an operation related to the first content can be controlled. In particular, the second external device 300 may identify the electronic device 100 currently used by the user, the electronic device 100 adjacent to the first external device 200, or the electronic device 100 for which the user's use frequency is high, etc. among the plurality of electronic devices 100, and transmit the information on the first content to the identified electronic device 100.

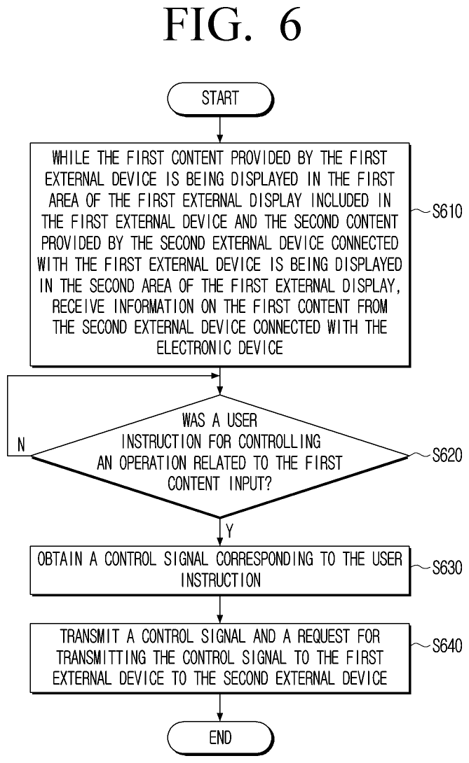

FIG. 6 is a flowchart illustrating an example method of controlling the electronic device 100 according to various embodiments.

As illustrated in FIG. 6, while the first content provided by the first external device 200 is being displayed in the first area of the first external display included in the first external device 200 and the second content provided by the second external device 300 connected with the first external device 200 is being displayed in the second area of the first external display, the electronic device 100 according to an embodiment of the disclosure may receive information on the first content from the second external device 300 connected with the electronic device 100 in operation S610.

For example, while the first content and the second content are being displayed as a multi-view in the first area and the second area of the first external display, the electronic device 100 may receive the information on the first content from the second external device 300 connected with the electronic device 100.

The electronic device 100 may receive input of an instruction (e.g., a user input or user instruction) for controlling an operation related to the first content in the step S620. When the information on the first content is received from the second external device 300, the processor 140 may control the display 120 to display a guide message indicating that the operation related to the first content can be controlled. When the user instruction for controlling the operation related to the first content is input, the electronic device 100 may obtain a control signal corresponding to the user instruction in operation S630.

According to an embodiment, the information on the first content may include image data corresponding to the first content. In this case, the processor 140 may control the display 120 to display the first content based on the image data. Also, a user instruction may be input based on the user's touch interaction regarding the area wherein the first content is displayed on the display 120.

According to an embodiment, the information on the first content may include information on the type of the first content. In this case, the processor 140 may control the display 120 to display a user interface (UI) corresponding to the type of the first content. A user instruction may be input through the UI displayed on the display 120.

According to an embodiment, the electronic device 100 may identify the user's gesture by detecting a movement of the electronic device 100 through the sensor, and identify a user instruction corresponding to the identified gesture among the plurality of control instructions corresponding to the type of the first content. According to an embodiment, the electronic device 100 may receive a user voice through the microphone, and identify a user instruction corresponding to the received user voice.

The electronic device 100 may transmit a control signal and a request for transmitting the control signal to the first external device 200 to the second external device 300 in operation S640.

For example, in case communicative connection was not performed between the electronic device 100 and the first external device 200, the processor 140 may make a control signal for controlling an operation related to the first content provided by the first external device 200 transmitted to the first external device 200 through the second external device 300.

The method of controlling the electronic device 100 according to various example embodiments may be implemented as a program, and provided to the electronic device 100. For example, the program including the controlling method for the electronic device 100 may be provided while being stored in a non-transitory computer-readable medium.

For example, in a non-transitory computer-readable recording medium including a program which, when executed by at least one processor, individually and/or collectively, of the electronic device 100, causes the electronic device 100 to perform operations comprising: while the first content provided by the first external device 200 is being displayed in the first area of the first external display included in the first external device 200 and the second content provided by the second external device 300 connected with the first external device 200 is being displayed in the second area of the first external display, receiving information on the first content from the second external device 300 connected with the electronic device 100, and based on a user instruction for controlling an operation related to the first content being input, obtaining a control signal corresponding to the user instruction, and transmitting the control signal and a request for transmitting the control signal to the first external device 200 to the second external device 300.

According to the aforementioned various embodiments of the disclosure, in case registration of the same user as the user of an external device was not performed, the electronic device 100 can effectively control a content that is being displayed on the first external device 200.

For example, in case the electronic device 100 is implemented as a tablet PC wherein the size of the display 120 is big, etc., the electronic device 100 can control an operation related to the first content based on a touch interaction according to the user's intuitive recognition by displaying the first content itself on the display 120, and in case the electronic device 100 is implemented as a smart watch wherein the size of the display 120 is not big, etc., the electronic device 100 can effectively control an operation related to the first content by displaying a UI corresponding to the type of the first content.

According to the disclosure, in case the electronic device 100 is implemented as a digital pen or wireless earphones which is a device that does not include the display 120, or that has portability or is appropriate for gesture recognition, the electronic device 100 can control an operation related to the first content based on a movement of the electronic device 100 according to the user's gesture or the user's voice.

Functions related to artificial intelligence according to the disclosure are operated through the processor 140 and the memory 130 of the electronic device.

The processor 140 include one or a plurality of processors 140. The one or plurality of processors 140 may include at least one of a central processing unit (CPU), a graphic processing unit (GPU), or a neural processing unit (NPU), but the processors are not limited to the aforementioned examples of processors 140.

A CPU is a generic-purpose processor 140 that can perform not only general operations but also artificial intelligence operations, and it can effectively execute a complex program through a multilayer cache structure. A CPU is advantageous for a serial processing method that enables a systemic linking between the previous calculation result and the next calculation result through sequential calculations. The generic-purpose processor 140 is not limited to the aforementioned examples excluding cases wherein it is specified as the aforementioned CPU.

A GPU is a processor 140 for mass operations such as a floating point operation used for graphie processing, etc., and it can perform mass operations in parallel by massively integrating cores. For example, a GPU may be advantageous for a parallel processing method such as a convolution operation, etc. compared to a CPU. A GPU may be used as a co-processor 140 for supplementing the function of a CPU. The processor 140 for mass operations is not limited to the aforementioned examples excluding cases wherein it is specified as the aforementioned GPU.

An NPU is a processor 140 specialized for an artificial intelligence operation using an artificial neural network, and it can implement each layer including an artificial neural network as hardware (e.g., silicon). Here, the NPU is designed to be specialized according to the required specification of a company, and thus it has a lower degree of freedom compared to a CPU or a GPU, but it can effectively process an artificial intelligence operation required by the company. As a processor 140 specialized for an artificial intelligence operation, an NPU may be implemented in various forms such as a tensor processing unit (TPU), an intelligence processing unit (IPU), a vision processing unit (VPU), etc. An artificial intelligence processor 140 is not limited to the aforementioned examples excluding cases wherein it is specified as the aforementioned NPU.

The one or plurality of processors 140 may be implemented as a system on chip (SoC). Here, in the SoC, the memory 130, and a network interface such as a bus for data communication between the processor 140 and the memory 130, etc. may be further included other than the one or plurality of processors 140.

In case the plurality of processors 140 are included in the system on chip (SoC) included in the electronic device, the electronic device may perform an operation related to artificial intelligence (e.g., an operation related to learning or inference of the artificial intelligence model) using some processors 140 among the plurality of processors 140. For example, the electronic device may perform an operation related to artificial intelligence using at least one of a GPU, an NPU, a VPU, a TPU, or a hardware accelerator specified for artificial intelligence operations such as a convolution operation, a matrix product operation, etc. among the plurality of processors 140. However, this is merely an example, and the electronic device can process an operation related to artificial intelligence using the generic-purpose processor 140 such as a CPU, etc.

The electronic device may perform operations regarding functions related to artificial intelligence using a multicore (e.g., a dual core, a quad core, etc.) included in one processor 140. In particular, the electronic device may perform artificial intelligence operations such as a convolution operation, a matrix product operation, etc. in parallel using the multicore included in the processor 140.

The one or plurality of processors 140 perform control such that input data is processed according to predefined operation rules or an artificial intelligence model stored in the memory 130. The predefined operation rules or the artificial intelligence model are characterized in that they are made through learning.

Being made through learning may refer, for example, to a learning algorithm being applied to a plurality of training data, and predefined operation rules or an artificial intelligence model having desired characteristics are thereby made. Such learning may be performed in a device itself wherein artificial intelligence is performed according to the disclosure, or through a separate server/system.

An artificial intelligence model may include a plurality of neural network layers. At least one layer has at least one weight value, and performs an operation of the layer through the operation result of the previous layer and at least one defined operation. As non-limiting examples of a neural network, there are a convolutional neural network (CNN), a deep neural network (DNN), a recurrent neural network (RNN), a restricted Boltzmann Machine (RBM), a deep belief network (DBN), a bidirectional recurrent deep neural network (BRDNN), deep Q-networks, a transformer, or the like, but the neural network in the disclosure is not limited to the aforementioned examples excluding specified cases.

A learning algorithm may refer, for example, to a method of training a specific subject device (e.g., a robot) using a plurality of training data and thereby making the specific subject device make a decision or make prediction by itself. As examples of learning algorithms, there are supervised learning, unsupervised learning, semi-supervised learning, or reinforcement learning, but learning algorithms in the disclosure are not limited to the aforementioned examples excluding specified cases.

A storage medium readable by machines may be provided in the form of a non-transitory storage medium. Here, the ‘a non-transitory storage medium’ storage medium is a tangible device, and may not include signals (e.g.: electromagnetic waves), and the term does not distinguish a case wherein data is stored in the storage medium semi-permanently and a case wherein data is stored temporarily. For example, ‘a non-transitory storage medium’ may include a buffer wherein data is temporarily stored.

According to an embodiment of the disclosure, the method according to the various embodiments described in the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or may be distributed directly between two user devices (e.g.: smartphones), and distributed on-line (e.g.: download or upload) through an application store (e.g.: Play Store™). In the case of on-line distribution, at least a portion of a computer program product (e.g.: a downloadable app) may be stored in a storage medium such as the server of the manufacturer, the server of the application store, and the memory 130 of the relay server at least temporarily, or may be generated temporarily.

Each of the components (e.g.: a module or a program) according to the aforementioned various embodiments of the disclosure may include a singular object or a plurality of objects. In addition, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner.

Further, operations performed by a module, a program, or other components according to the various embodiments may be executed sequentially, in parallel, repetitively, or heuristically. Or, at least some of the operations may be executed in a different order or omitted, or other operations may be added.

In the disclosure, the term “part” or “module” used in the disclosure may include a unit implemented as hardware, software, or firmware, or any combination thereof, and may be interchangeably used with, for example, terms such as a logic, a logical block, a component, or a circuit. In addition, “a part” or “a module” may be a component including an integrated body or a minimum unit or a part thereof performing one or more functions. For example, a module may include an application-specific integrated circuit (ASIC).

The various embodiments of the disclosure may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: the electronic device 100).

In case an instruction is executed by a processor, the processor may perform a function corresponding to the instruction by itself, or using other components under its control. An instruction may include a code that is generated or executed by a compiler or an interpreter.

While the disclosure has been illustrated and described with reference to various example embodiments, the disclosure is not limited to the aforementioned example embodiments, and it will be apparent that various modifications may be made by those of ordinary skill in the art, without departing from the gist of the disclosure including the appended claims and their equivalents. It will also be understood that any of the embodiment(s) described herein may be used in conjunction with any other embodiment(s) described herein.

What is claimed is:

1. An electronic device comprising:
a communicator comprising communication circuitry;
a display;
memory; and
at least one processor, comprising processing circuitry, individually and/or collectively, configured to:
while a first content provided by a first external device is being displayed in a first area of a first external display included in the first external device and a second content provided by a second external device connected with the first external device is being displayed in a second area of the first external display, receive information on the first content from the second external device connected with the electronic device through the communicator,
based on an instruction for controlling an operation related to the first content being input, obtain a control signal corresponding to the instruction, and
control the communicator to transmit the control signal and a request for transmitting the control signal to the first external device to the second external device.

2. The electronic device of claim 1,
wherein the information on the first content includes image data corresponding to the first content, and
at least one processor, individually and/or collectively, is configured to:
based on the image data, control the display to display the first content, and
the instruction is input based on a touch interaction for the area wherein the first content is displayed on the display.

3. The electronic device of claim 1,
wherein the information on the first content includes information on a type of the first content, and
at least one processor, individually and/or collectively, is configured to:
control the display to display a user interface (UI) corresponding to the type of the first content, and
wherein the instruction is input through the UI.

4. The electronic device of claim 3, further comprising:
a sensor,
wherein the instruction is input based on the gesture detected through the sensor, and
wherein the instruction corresponds to one of a plurality of control instructions corresponding to the type of the first content.

5. The electronic device of claim 3, further comprising:
a microphone,
wherein the instruction is input based on at least one voice received through the microphone, and
wherein the instruction corresponds to one of a plurality of control instructions corresponding to the type of the first content.

6. The electronic device of claim 1,
wherein a user registered to the electronic device is the same as the user registered to the second external device, and is a user not registered to the first external device.

7. The electronic device of claim 1,
wherein the second content is a content currently being displayed on a second external display included in the second external device.

8. The electronic device of claim 1,
wherein the second content is a content transmitted from a server to the first external device based on an input input through the second external device.

9. The electronic device of claim 1,
wherein at least one processor, individually and/or collectively, is configured to:
based on receiving the information on the first content from the second external device through the communicator, control the display to display a guide message indicating that the operation related to the first content can be controlled.

10. A method of controlling an electronic device, the method comprising:
while a first content provided by a first external device is being displayed in a first area of a first external display included in the first external device and a second content provided by a second external device connected with the first external device is being displayed in a second area of the first external display, receiving information on the first content from the second external device connected with the electronic device;
based on an instruction for controlling an operation related to the first content being input, obtaining a control signal corresponding to the instruction; and
transmitting the control signal and a request for transmitting the control signal to the first external device to the second external device.

11. The method of controlling an electronic device of claim 10,
wherein the information on the first content includes image data corresponding to the first content, and
the method of controlling an electronic device further comprises:
based on the image data, displaying the first content, and
wherein the instruction is input based on a touch interaction for the area wherein the first content is displayed on the display.

12. The method of controlling an electronic device of claim 10,
wherein the information on the first content includes information on a type of the first content, and
the method of controlling an electronic device further comprises:
displaying a user interface (UI) corresponding to the type of the first content, and
wherein the instruction is input through the UI.

13. The method of controlling an electronic device of claim 12,
wherein the instruction is input based on the gesture, and
wherein the instruction corresponds to one of a plurality of control instructions corresponding to the type of the first content.

14. The method of controlling an electronic device of claim 12,
wherein the instruction is input based on at least one voice, and
wherein the instruction corresponds to one of a plurality of control instructions corresponding to the type of the first content.

15. A non-transitory computer-readable recording medium including a program which, when executed by at least one processor, individually and/or collectively, of an electronic device, causes the electronic device to perform operations comprising:
while a first content provided by a first external device is being displayed in a first area of a first external display included in the first external device and a second content provided by a second external device connected with the first external device is being displayed in a second area of the first external display, receiving information on the first content from the second external device connected with the electronic device;
based on an instruction for controlling an operation related to the first content being input, obtaining a control signal corresponding to the instruction; and
transmitting the control signal and a request for transmitting the control signal to the first external device to the second external device.
